(19) United States
(12) Patent Application Publication
(10) Pub. No.: US 2015/0293786 A1
(43) Pub. Date: Oct. 15, 2015

(54) METHOD FOR PROCESSING CR ALGORITHM BY ACTIVELY UTILIZING SHARED MEMORY OF MULTI-PROCESSOR, AND PROCESSOR USING THE SAME

(71) Applicant: KOREA ELECTRONICS TECHNOLOGY INSTITUTE, Seongnam-si (KR)

(72) Inventors: Hye Dong JUNG, Seoul (KR); Jae Gi SON, Yongin-si (KR)

(21) Appl. No.: 14/564,508

(22) Filed: Dec. 9, 2014

(30) Foreign Application Priority Data
Apr. 11, 2014 (KR) 10-2014-0043422

(51) Int. Cl. G06F 9/48; G06F 12/02; G06F 9/52

(52) U.S. Cl. CPC G06F 9/4881; G06F 9/52; G06F 12/023; G06F 2212/1041; G06F 2212/251

(57) ABSTRACT

A method for processing a CR algorithm by actively utilizing a shared memory of a multi-processor, and a processor using the same are provided. A processor includes: a first multi-processor configured to process a first group of elements of a matrix in accordance with an algorithm; a second multi-processor configured to process a second group of the elements of the matrix in accordance with the algorithm; and a third multi-processor configured to process a third group which comprises some of the elements of the first group, some of the elements of the second group, and some of the elements which are not comprised in the first group and the second group, in accordance with the algorithm. Accordingly, a TDM having many elements can be calculated fast.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Apr. 11, 2014, and assigned Serial No. 10-2014-0043422, the entire disclosure of which is hereby incorporated by reference.

### TECHNICAL FIELD OF THE INVENTION

The present invention relates generally to Cyclic Reduction (CR) algorithm processing, and more particularly, to a CR algorithm processing method for solving a Tri-Diagonal Matrix (TDM), and a processor using the same.

### BACKGROUND OF THE INVENTION

The TDM solver is an algorithm used in Computational Fluid Dynamics (CFD). However, since the TDM solver has a problem in a calculation speed, methods for processing the TDM in parallel in accordance with the CR algorithm are widely used.

FIG. 1 is a view to explain a related-art method for processing a TDM in parallel in accordance with a CR algorithm.

As shown in FIG. 1, elements of the TDM are divided by a predetermined number such that a number of elements (7 elements) a Multi Processor (MP) can process at a time are grouped, and are allocated to the MPs. As shown in FIG. 1, the 0^{th} to 6^{th} elements of the TDM are processed by one MP, and the 8^{th} to 14^{th} element are processed by the other MP.

The CR algorithm processing by the two MPs is performed very fast because the elements are stored into a shared memory and calculated. However, the subsequent CR algorithm processing regarding the 7^{th} element is required to access a global memory for calculation and thus is performed very slowly.

As a result, it takes much time to process the TDM in accordance with the CR algorithm and thus there is a problem that a CFD speed regarding an image decreases.

### SUMMARY OF THE INVENTION

To address the above-discussed deficiencies of the prior art, it is a primary aspect of the present invention to provide a method for processing a CR algorithm by actively utilizing a shared memory of a multi-processor which has a fast access speed, instead of a global memory which has a slow access speed, and a processor using the same.

According to one aspect of the present invention, a processor includes: a first multi-processor configured to process a first group of elements of a matrix in accordance with an algorithm; a second multi-processor configured to process a second group of the elements of the matrix in accordance with the algorithm; and a third multi-processor configured to process a third group which includes some of the elements of the first group, some of the elements of the second group, and some of the elements which are not included in the first group and the second group, in accordance with the algorithm.

The third multi-processor may be configured to access a third shared memory in which the elements of the third group are stored, and process the algorithm.

The first multi-processor may be configured to access a first shared memory in which the elements of the first group are stored, and process the algorithm, and the second multi-processor may be configured to access a second shared memory in which the elements of the second group are stored, and process the algorithm.

When the matrix is expressed by one-dimensional vector, the elements of the first group may come faster than the elements of the second group.

The elements included in both the first group and the third group may come slower than the elements included only in the first group.

The elements included in both the second group and the third group may come faster than the elements included only in the second group.

The elements of the first group and the elements of the second group may not overlap with each other.

The matrix may be a Tri-Diagonal Matrix (TDM).

The algorithm may be a Cyclic Reduction (CR) algorithm for the TDM.

According to another aspect of the present invention, an algorithm processing method includes: processing, by a first multi-processor, a first group of elements of a matrix in accordance with an algorithm; processing, by a second multi-processor, a second group of the elements of the matrix in accordance with the algorithm; and processing, by a third multi-processor, a third group which includes some of the elements of the first group, some of the elements of the second group, and some of the elements which are not included in the first group and the second group, in accordance with the algorithm.

According to exemplary embodiments as described above, a CR algorithm is processed by actively utilizing a shared memory of a multi-processor which has a fast access speed, instead of a global memory which has a slow access speed. Therefore, a TDM having many elements can be calculated fast.

In particular, the entire algorithm performance can be improved by increasing optimum parallelism in the field of medical image processing, 3D visualization, etc.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view to explain a related-art method for processing a TDM in parallel in accordance with a CR algorithm;

FIG. 2 is a block diagram of a General Purpose-Graphics Processing Unit (GP-GPU) according to an exemplary embodiment of the present invention; and

FIG. 3 is a view to explain a method for the GP-GPU of FIG. 2 to process a TDM in accordance with a CR algorithm.

### DETAILED DESCRIPTION OF THE INVENTION

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

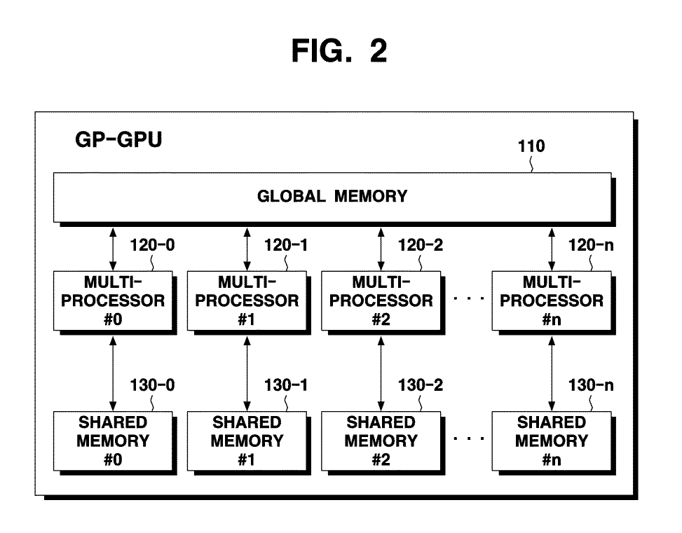

FIG. 2 is a block diagram of a GP-GPU according to an exemplary embodiment of the present invention. The GP-GPU according to an exemplary embodiment of the present invention is a processor for performing medical image processing and 3-dimensional visualization.

The GP-GPU according to an exemplary embodiment of the present invention processes a TDM in accordance with a CR algorithm.

The GP-GPU which performs the above-described function includes a global memory 110, multi-processors 120-0, 120-1, 120-2, . . . , 120-n, and shared memories 130-0, 130-1, 130-2, . . . , 130-n, as shown in FIG. 2.

Each of the multi-processors 120-0, 120-1, 120-2, . . . , 120-n includes a plurality of unit-processors (not shown). That is, the GP-GPU shown in FIG. 2 has a multiple multi-processor configuration.

The multi-processors 120-0, 120-1, 120-2, . . . , 120-n process an algorithm in parallel. That is, the GP-GPU shown in FIG. 2 is a processor that is able to process in parallel by means of the multi-processors 120-0, 120-1, 120-2, . . . , 120-n.

The global memory 110 is a memory that can be accessed by all of the multi-processors 120-0, 120-1, 120-2, . . . , 120-n, whereas the shared memories 130-0, 130-1, 130-2, . . . , 130-n are memories which can be accessed only by corresponding multi-processors.

Specifically, 0) shared-memory #0 130-0 can be accessed only by multi-processor #0 120-0, 1) shared-memory #1 130-1 can be accessed only by multi-processor #1 120-1, 2) shared-memory #2 130-2 can be accessed only by multi-processor #2 (120-2), . . . , and n) shared-memory #n 130-n can be accessed only by multi-processor #n (120-n).

Of course, the shared-memories 130-1, 130-1, 130-2, . . . , 130-n, which can be accessed only by corresponding multi-processors, have a fast access speed, compared to the global-memory 110 which can be accessed by all of the multi-processors 120-0, 120-1, 120-2, . . . , 120-n.

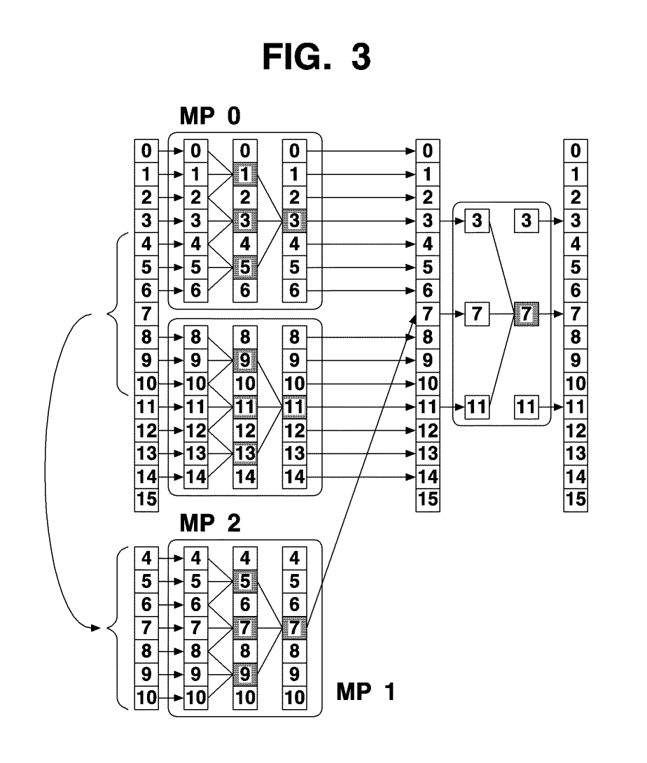

Hereinafter, a method for the GP-GPU of FIG. 2 to process a TDM in accordance with a CR algorithm will be explained in detail with reference to FIG. 3.

As shown in FIG. 3, MP0 (multi-processor #0 120-0) processes some of the elements of the TDM (0^{th} to 6^{th} elements) in accordance with the CR algorithm, and MP2 (multi-processor #2 120-2) processes some of the other elements (8^{th} to 14^{th} elements) of the TDM in accordance with the CR algorithm.

MP0 (multi-processor #0 120-0) processes the fore elements of the TDM (0^{th} to 6^{th} elements). Specifically, when the TDM is expressed by a one-dimensional vector, MP0 is allocated elements which come early (0^{th} to 6^{th} elements) and processes the elements.

On the other hand, MP2 (multi-processor #2 120-2) processes the back elements of the TDM (8^{th} to 14^{th} elements). Specifically, when the TDM is expressed by the one-dimensional vector, MP2 is allocated elements which come late (8^{th} to 14^{th} elements) and processes the elements.

The elements (0^{th} to 6^{th} elements) processed by MP0 (multi-processor #0 120-0) and the elements (8^{th} to 14^{th} elements) processed by MP2 (multi-processor #2 120-2) do not overlap with each other.

MP1 (multi-processor #1 120-1) processes some of the elements of the TDM (4^{th} to 10^{th} elements) in accordance with the CR algorithm.

Processing by MP1 (multi-processor #1 120-1) is performed in parallel with processing by MP0 (multi-processor #0 120-0) and processing by MP2 (multi-processor #2 120-2). That is, processing by MP0 (multi-processor #0 120-0, processing by MP1 (multi-processor #1 120-1), and processing by MP2 (multi-processor #2 120-2) are performed at the same time.

MP1 (multi-processor #1 120-1) processes the middle elements of the TDM (4^{th} to 10^{th} elements). Specifically, when the TDM is expressed by the one-dimensional vector, MP1 is allocated elements which are in the middle (4^{th} to 10^{th} elements) and processes the elements.

Accordingly, the elements processed by MP1 (multi-processor #1 120-1) partially overlaps with the elements processed by MP0 (multi-processor #0 120-0) and partially overlaps with the elements processed by MP2 (multi-processor #2 120-2).

Specifically, MP1 (multi-processor #1 120-1) is allocated elements (4^{th} to 6^{th} elements) which come late from among the elements processed by MP0 (multi-processor #0 120-0), and processes the elements, and MP2 (multi-processor #2 120-2) is allocated elements (8^{th} to 10^{th} elements) which come early from among the elements processed by MP2 (multi-processor #2 120-2) and processes the elements.

In addition, MP1 (multi-processor #1 120-1) is allocated elements (7^{th} elements) which are not processed by MP0 (multi-processor #0 120-0) and MP2 (multi-processor #2 120-2), and process the elements.

MP0 (multi-processor #0 120-0) stores the allocated elements in shared memory #0 130-0 and uses them, MP1 (multi-processor #1 120-1) stores the allocated elements into shared memory #1 130-1 and uses them, and MP2 (multi-processor #2 120-2) stores the allocated elements into shared memory #2 130-2 and uses them.

Accordingly, since MP0 (multi-processor #0 120-0), MP1 (multi-processor #1 120-1), and MP2 (multi-processor #2 120-2) do not use the global memory 110 in processing the elements in accordance with the CR algorithm, the access speed increases and thus the processing speed increases.

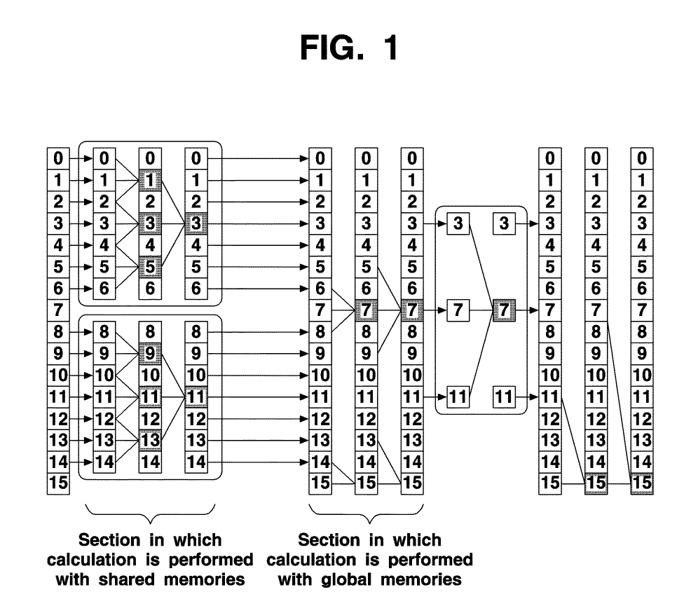

Furthermore, a global memory calculation section, as shown in FIG. 1, is not required and the entire processing speed can increases as much as time of that section is reduced.

When processing by MP0 (multi-processor #0 120-0), MP1 (multi-processor #1 120-1), and MP2 (multi-processor #2 120-2) is completed, one of these multi-processors processes 3^{rd}, 7^{th}, and 11^{th} elements in accordance with the CR algorithm(i), processes 11^{th} and 15^{th} elements in accordance with CR algorithm(ii), and processes 7^{th} and 15^{th} elements in accordance with the CR algorithm (iii).

The processing (i), (ii), and (iii) are performed by storing the elements into the corresponding shared memories and accessing the shared memories.

Up to now, a method for processing a CR algorithm by actively utilizing a shared memory of a multi-processor, and a GP-GPU using the same have been described with reference to exemplary embodiments.

In the above-described exemplary embodiments, the number of elements of the TDM is 16. However, this is merely an example for convenience of understanding and explanation and the technical idea of the present disclosure is applicable to a TDM having a different size.

In addition, in the above-described exemplary embodiment, the TDM is processed in accordance with the CR algorithm. However, this is merely an example for convenience of understanding and explanation. The technical idea of the present disclosure is applicable when the TDM is substituted with other kinds of matrices, and the CR algorithm is substituted with other kinds of algorithms.

In addition, the technical idea of the present disclosure is applicable when other kinds of processors than the GP-GPU are implemented.

Furthermore, the technical idea of the present disclosure can be utilized in communication, encryption, etc. as well as image processing fields such as medical image processing, 3D visualization, etc.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A processor comprising:
a first multi-processor configured to process a first group of elements of a matrix in accordance with an algorithm;
a second multi-processor configured to process a second group of the elements of the matrix in accordance with the algorithm; and
a third multi-processor configured to process a third group which comprises some of the elements of the first group, some of the elements of the second group, and some of the elements which are not comprised in the first group and the second group, in accordance with the algorithm.

2. The processor of claim 1, wherein the third multi-processor is configured to access a third shared memory in which the elements of the third group are stored, and process the algorithm.

3. The processor of claim 2, wherein the first multi-processor is configured to access a first shared memory in which the elements of the first group are stored, and process the algorithm, and
wherein the second multi-processor is configured to access a second shared memory in which the elements of the second group are stored, and process the algorithm.

4. The processor of claim 1, wherein, when the matrix is expressed by one-dimensional vector, the elements of the first group come faster than the elements of the second group.

5. The processor of claim 4, wherein the elements comprised in both the first group and the third group come slower than the elements comprised only in the first group.

6. The processor of claim 5, wherein the elements comprised in both the second group and the third group come faster than the elements comprised only in the second group

7. The processor of claim 1, wherein the elements of the first group and the elements of the second group do not overlap with each other.

8. The processor of claim 1, wherein the matrix is a Tri-Diagonal Matrix (TDM).

9. The processor of claim 8, wherein the algorithm is a Cyclic Reduction (CR) algorithm for the TDM.

10. An algorithm processing method comprising:
processing, by a first multi-processor, a first group of elements of a matrix in accordance with an algorithm;
processing, by a second multi-processor, a second group of the elements of the matrix in accordance with the algorithm; and
processing, by a third multi-processor, a third group which comprises some of the elements of the first group, some of the elements of the second group, and some of the elements which are not comprised in the first group and the second group, in accordance with the algorithm.
